(19) United States
(12) Patent Application Publication
(10) Pub. No.: US 2010/0053433 A1
(43) Pub. Date: Mar. 4, 2010

(54) DIGITAL PHOTO FRAME WITH MODE SWITCH FUNCTION AND METHOD THEREOF

(75) Inventors: CHIA-YU CHENG, Tu-Cheng (TW); ZAI-AN PAN, Shenzhen City (CN); KUAN-HONG HSIEH, Tu-Cheng (TW); HAN-CHE WANG, Tu-Cheng (TW); SHIN-HONG CHUNG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HON FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/421,582

(22) Filed: Apr. 9, 2009

(30) Foreign Application Priority Data
Aug. 28, 2008 (CN) 200810304259.X

(51) Int. Cl. H04N 5/44

(52) U.S. Cl. 348/553; 348/E05.096

(57) ABSTRACT

A method of a digital photo frame (DPF) with mode switching function is provided. The method includes: determining whether the DPF is in a DPF mode or a TV mode upon receiving a power off signal; detecting whether any multimedia file exists in the DPF if the DPF is in the TV mode; and switching the DPF from the TV mode to the DPF mode if any multimedia file exists in the storage. A related DPF is also provided.

### BACKGROUND

1. Technical Field

The present disclosure relates to a digital photo frame (DPF) with mode switch function and, especially, to a DPF capable of switching from a TV mode to a DPF mode and a method thereof.

2. Description of Related Art

Along with the rapid development in electronic technology, DPFs have become familiar to consumers. Some types of DPFs have been designed to not only display photos, but also receive television (TV) programs.

When a user uses a DPF to watch TV programs in a TV mode, after his or her favorite TV program ends and the user does not want to watch any other programs, it is customary for the user to terminate the TV mode using a power button of the DPF, just liking what he or she does to a TV set after he or she finishes watching TV programs using the TV set. However, this customary or habitual action may bring some trouble to the user if the user does not mean to power off the DPF but wants to instead browse through photos or the like in a DPF mode. The user has to power on the DPF again and switch the DPF from the TV mode to the DPF mode before he or she can browse through photos or the like.

### BRIEF DESCRIPTION OF THE DRAWINGS

The components of the drawings are not necessarily drawn to scale, the emphasis instead being placed upon clearly illustrating the principles of a digital photo frame (DPF) with mode switch function and a method thereof. Moreover, in the drawings, like reference numerals designate corresponding parts throughout several views.

FIG. 1 is a front view of a DPF with mode switch function in accordance with an exemplary embodiment.

FIG. 2 is a block diagram of the DPF of FIG. 1 in accordance with an exemplary embodiment.

FIG. 3 is a flowchart illustrating a mode switch method of the DPF of FIG. 1 in accordance with an exemplary embodiment.

### DETAILED DESCRIPTION

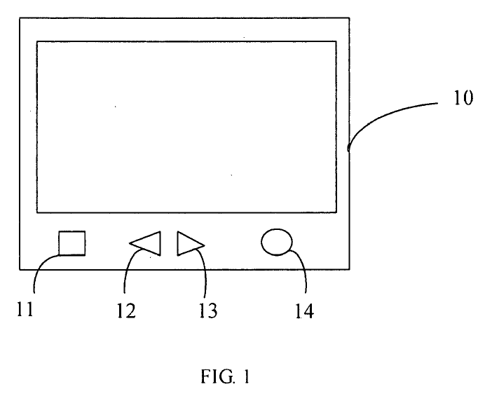

FIG. 1 is a front view of a digital photo frame (DPF) 10 with mode switch function in accordance with an exemplary embodiment.

The DPF 10 mainly includes a power button 11, a previous button 12, a next button 13 and a switch button 14. The power button 11 is configured for powering on and powering off the DPF 10. The switch button 14 is configured for manually switching an operation mode of the DPF 10 between a DPF mode and a television (TV) mode. When the DPF 10 is in the DPF mode, the previous button 12 and the next button 13 are configured for paging through multimedia files such as photos stored in the DPF 10. When the DPF 10 is in the TV mode, the previous button 12 and the next button 13 are configured for changing TV channels.

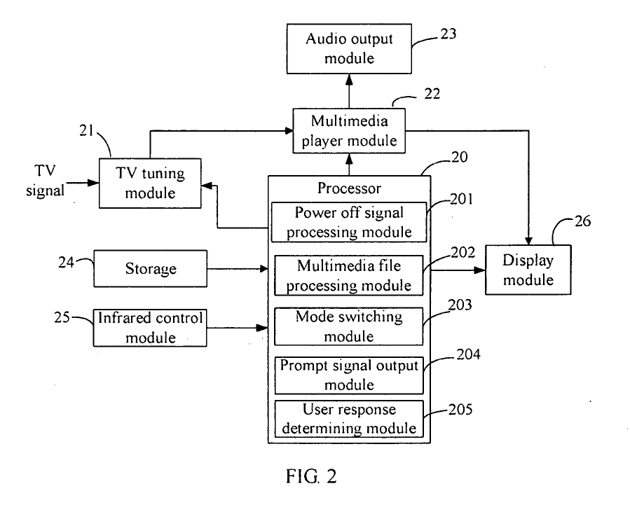

FIG. 2 is a block diagram of the DPF 10 in accordance with an exemplary embodiment.

The DPF 10 includes a processor 20 connected to a TV tuning module 21, a multimedia player module 22, a storage 24, and a display module 26, which are controlled by the processor 20.

The storage 24 is configured for storing multimedia files. The multimedia files may include photos, audio files, video files, and so on. The storage 24 can be either a built-in memory of the DPF 10 or an exterior memory, such as a secure digital (SD) card, a compact flash (CF) card, and so on. When the DPF 10 is in the DPF mode, the processor 20 fetches the multimedia files from the storage 24 and transfers the multimedia files to the multimedia player module 22. The multimedia player module 22 then reproduces image/video/audio data of the multimedia files. When the DPF 10 is in the TV mode, the TV tuning module 21 is controlled by the processor 20 to receive TV signals and transfers the TV signals to the multimedia player module 22. The TV tuning module 21 may receive TV signals by any usual means such as via an antenna (not shown) or a cable (not shown). The multimedia player module 22 then reproduces image/video/audio data. The multimedia player module 22 is connected to an audio output module 23 (e.g., a speaker) and the display module 26. The audio output module 23 is configured to output audio data of the multimedia files and the TV programs. The display module 26 is configured to output image/video data of the multimedia files and the TV programs.

The storage 24 is further configured for storing a prompt signal. The prompt signal may be a text message and/or an audible alert, to notify the users no multimedia file exists in the storage 24.

The DPF 10 can also include an infrared control module 25. The infrared control module 25 is configured for receiving infrared control signals from a remote control (not shown) and converts the infrared control signals to digital serial signals. The digital serial signals are sent to the processor 20 and the processor 20 adjusts various parameters of the controllable modules according to the digital serial signals. The previous button 13 and the next button 14 can also be integrated onto the remote control to control the play of the multimedia files and TV programs.

The processor 20 includes a power off signal processing module 201, a multimedia file processing module 202, a mode switching module 203, a prompt signal output module 204, and a user response determining module 205.

The power off signal processing module 201 is configured for determining whether the DPF 10 is in the DPF mode or in the TV mode, upon receiving a power off signal transferred from the power button 11. In the exemplary embodiment, the power off signal processing module 202 determines that the DPF 10 is in the DPF mode if the power off signal processing module 202 determines that the multimedia file processing module 202 is fetching the multimedia files from the storage 24, otherwise the power off signal processing module 201 determines that the DPF 10 is in the TV mode.

The multimedia file processing module 202 is configured for detecting whether any multimedia file exists in the storage 24 if the power off signal processing module 201 determines the DPF 10 is in the TV mode.

The mode switching module 203 is configured for switching an operation mode of the DPF 10 between the DPF mode and the TV mode. In the exemplary embodiment, if the multimedia file processing module 202 determines the storage 24 stores multimedia files, the multimedia file processing module 202 signals the mode switching module 203 to switch the DPF from the TV mode to the DPF mode. The multimedia file processing module 202 then fetches the multimedia files from the storage 24 and outputs the multimedia files via the multimedia player module 22.

The prompt signal output module 204 is configured to fetch the prompt signal from the storage 24 and output the prompt signal via the multimedia player module 22 if no multimedia file exists in the storage 24.

The user response determining module 205 is configured for determining whether there is a user response to the prompt signal within the output of the prompt signal. In the exemplary embodiment, if the user response determining module 205 determines that there is a user response to the prompt signal within the output of the prompt signal, the user response determining module 205 signals other modules of the processor 20 to execute operations in relation to the user response.

For example, if the prompt signal is a dialog box and the dialog box is displayed on the display module 26 to notify the users that no multimedia file exists in the storage 24 and ask the users to insert a memory card into the DPF 10 or connect another type of storage apparatus to the DPF 10. If the user inserts a memory card into the DPF 10 or connects another storage apparatus to the DPF f10 complying with the request of the dialog box, the user response determining module 205 signals the multimedia file processing module 202 to fetch multimedia files from the memory card. The multimedia file processing module 202 then transfers the multimedia files to the multimedia player module 22 and the multimedia player module 22 reproduces the multimedia files in the DPF mode.

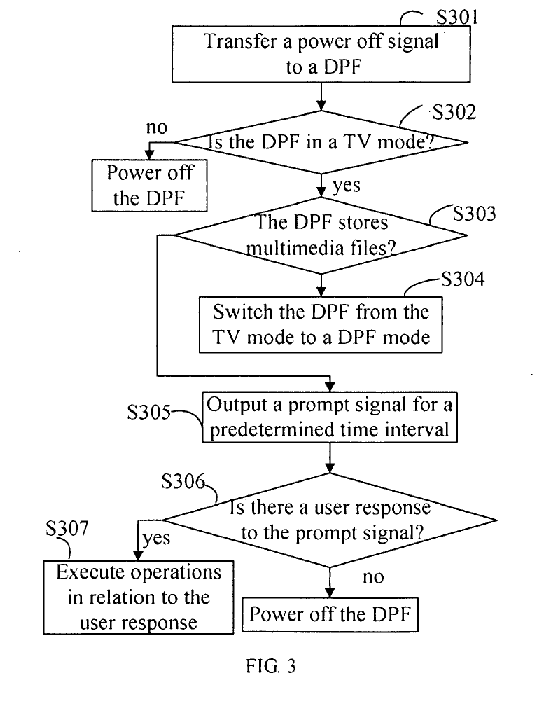

FIG. 3 is a flowchart illustrating a mode switch function of the DPF 10 in accordance with an exemplary embodiment.

In step S301, the power button 11 is operated to produce a power off signal.

In step S302, the power off signal processing module 201 determines whether the DPF 10 is in the DPF mode or in the TV mode, upon receiving the power off signal. If the DPF 10 is in the TV mode, the DPF 10 executes steps described below. If the DPF 10 is in the DPF mode, the power off signal processing module 201 powers off the DPF 10.

In step S303, the power off signal processing module 201 signals the multimedia file processing module 202 to determine whether any multimedia file exists in the storage 24. In the exemplary embodiment, if any multimedia file exists in the storage 24, the procedure goes to step S304, otherwise the procedure forwards to step S305. In an alternative embodiment, if no multimedia file exists in the storage 24, the power off signal processing module 201 directly powers off the DPF 10.

In step S304, the multimedia file processing module 202 signals the mode switching module 203 to switch the DPF 10 from the TV mode to the DPF mode. The multimedia file processing module 202 then fetches the multimedia files from the storage 24 and transfers the multimedia files to the multimedia player module 22. The multimedia player module 22 then reproduces the multimedia files in the DPF mode.

In step S305, the prompt signal output module 204 fetches the prompt signal from the storage 24 and transfers the prompt signal to the multimedia player module 22. The multimedia player module 22 outputs the prompt signal for a predetermined time interval to notify the users that no multimedia file exists in the storage 24.

In step S306, during the output of the prompt signal, the user response determining module 205 determines whether there is a user response to the prompt signal. If there is no user response to the prompt signal, the user response determining module 20 signals the power off signal processing module 201 to power off the DPF 10, otherwise the process goes to step S307.

In step S307, the user response determining module 205 signals other modules of the processor 20 to execute operations in relation to the user response.

Although the present disclosure has been specifically described on the basis of preferred embodiments and method thereof, the disclosure is not to be construed as being limited thereto. Various changes or modifications may be made to the embodiments without departing from the scope and spirit of the invention.

What is claimed is:

1. A digital photo frame (DPF) with mode switch function comprising a DPF mode and a television (TV) mode, comprising:
a storage configured for storing multimedia files;
a processor comprising:
a power off signal processing module configured for determining whether the DPF is in the DPF mode or in the TV mode, upon receiving a power off signal transferred from a power button of the DPF;
a multimedia file processing module configured for determining whether any multimedia file exists in the storage if the power off signal processing module determines that the DPF is in the TV mode; and
a mode switching module configured for switching the DPF from the TV mode to the DPF mode if the multimedia file processing module determines that the storage stores multimedia files.

2. The DPF as described in claim 1, wherein the power off signal processing module is further configured for powering off the DPF if the power off signal processing module determines that the DPF is in the DPF mode upon receiving the power off signal.

3. The DPF as described in claim 1, wherein the power off signal processing module is further configured for powering off the DPF if the multimedia file processing module determines that no multimedia file exists in the storage.

4. The DPF as described in claim 1, wherein the storage is further configured for storing a prompt signal.

5. The DPF as described in claim 4, wherein the processor further comprises a prompt signal output module configured for fetching the prompt signal from the storage if the multimedia file processing module determines that no multimedia file exists in the storage, and outputting the prompt signal for a predetermined time interval to notify users that no multimedia file exists in the storage.

6. The DPF as described in claim 5, wherein the processor further comprises a user response determining module configured for determining whether there is user response to the prompt signal within the output of the prompt signal, and further signaling modules of the processor to execute operations in relation to the user response if there is a user response to the prompt signal, and signaling the power off signal processing module to power off the DPF if there is no user response to the prompt signal.

7. The DPF as described in claim 6, wherein the prompt signal is for asking users to insert a memory card into the DPF, and the user response determining module is configured for determining that there is a user response to the prompt signal if the user inserts a memory card into the DPF, and signaling the multimedia file processing module to fetch multimedia files from the memory card.

8. A method of a digital photo frame (DPF) with mode switch function comprising a DPF mode and a television (TV) mode, the method comprising:
determining whether the DPF is in the DPF mode or in the TV mode upon receiving a power off signal;
determining whether any multimedia file exists in the DPF if the DPF is in the TV mode; and
switching the DPF from the TV mode to the DPF mode if any multimedia file exists in the DPF.

9. The method as described in claim 8, further comprising:
powering off the DPF if the DPF is in the DPF mode.

10. The method as described in claim 8, further comprising:
powering off the DPF if no multimedia file exists in the DPF.

11. The method as described in claim 8, further comprising:
outputting a prompt signal for a predetermined time interval if no multimedia file exists in the DPF;
determining whether there is user response to the prompt signal within the output of the prompt signal;
executing operations in relation to the user response if there is user response to the prompt signal within the output of the prompt signal; and
powering off the DPF if there is no user response to the prompt signal.
